(19) United States
(12) Patent Application Publication
(10) Pub. No.: US 2014/0176679 A1
(43) Pub. Date: Jun. 26, 2014

(54) Method for Automatically Classifying Moving Vehicles

(71) Applicant: JENOPTIK Robot GmbH, Monheim (DE)

(72) Inventor: Michael LEHNING, Hildesheim (DE)

(73) Assignee: JENOPTIK Robot GmbH, Monheim (DE)

(21) Appl. No.: 14/136,527

(22) Filed: Dec. 20, 2013

(30) Foreign Application Priority Data
Dec. 21, 2012 (DE) DE102012113009.4

(51) Int. Cl. H04N 13/02

(52) U.S. Cl. CPC H04N 13/0275
USPC 348/46

(57) ABSTRACT

The invention is directed to a method for classifying a moving vehicle. The object of the invention is to find a novel possibility for classifying vehicles moving in traffic which allows a reliable automatic classification based on two-dimensional image data. This object is met according to the invention in that an image of a vehicle is recorded by means of a camera and the position and perspective orientation of the vehicle are determined therefrom, rendered two-dimensional views are generated from three-dimensional vehicle models which are stored in a database in positions along an anticipated movement path of the vehicle and are compared with the recorded image of the vehicle, and the vehicle is classified from the two-dimensional view found to have the best match by assignment of the associated three-dimensional vehicle model.

### RELATED APPLICATIONS

The present application claims priority benefit of German Application No. DE 10 2012 113 009.4 filed on Dec. 21, 2012, the contents of which is incorporated by reference in its entirety.

### FIELD OF THE INVENTION

The invention is directed to a method for classifying a moving vehicle which can be used in particular for reliable automatic classification of vehicles which are recorded by a video-assisted traffic monitoring installation.

### BACKGROUND OF THE INVENTION

Methods using external features for recognizing or classifying motor vehicles are known from the prior art. These methods are often employed for charging road tolls based on vehicle class or in conjunction with speed-measuring devices for monitoring speed limits. Generally in these methods the signals from one or more sensors detecting the vehicles are evaluated. Image-generating sensors which allow the license plate to be evaluated are frequently used to carry out an identification of the detected vehicles simultaneously.

In the examples mentioned above, it is usually sufficient to roughly classify the detected vehicles into the passenger car class or truck class. In EP 1 997 090 B1, the three-dimensional shape of a moving vehicle is determined from a plurality of consecutive recordings by a camera positioned next to the traffic lane. The determined shape is then used to identify the vehicle type by comparing it with shapes from a database which has been compiled beforehand. This is disadvantageous in that a plurality of recordings are needed to determine the vehicle type and the recordings must be made in the same position in which the comparison images from the database were made.

In a method described in DE 101 48 289 A1, vehicles can be classified while in motion. The method is applied specifically for monitoring and charging a truck toll. The vehicles are first detected and tracked by means of LIDAR sensors by means of which the distance traveled and the velocity of the vehicle can be estimated. The vehicle is then recorded by cameras and measured by additional sensors. The license plate can be determined from the camera images by means of text recognition data processing. The preferred additional sensors are laser sensors by means of which contour data and structural data such as cross section, length, number of wheel axles and manufacturer's markings of the vehicle (vehicle make) can be determined. The determined LIDAR data are associated with the determined contour data and structural data. The accuracy of the measurement results can be further improved by applying statistical methods for evaluating a plurality of measurements of the vehicle. Based on the principle of measurement and of acquiring measurement values, it may be concluded that the measurement is relatively rough. The applied method is intended exclusively for distinguishing and classifying trucks which are subject to tolls and which can be recognized relatively easily based on the large dimensions, number of axles and characteristic shape. This method is obviously sufficiently accurate for this purpose. It must be assumed that the differentiating accuracy of the method is not sufficient for classification in the passenger car class which has a great variety of shapes. The necessity of determining three-dimensional data with a plurality of sensors for classifying the vehicle itself may be considered a drawback. This increases the expenditure on material for acquiring and processing the data. Detection of wheel axles and manufacturer's markings aside, it is not possible to evaluate further structures of the vehicle exterior or vehicle interior in more detail.

It is the object of the invention to find a novel possibility for classifying vehicles moving in traffic which allows a reliable automatic classification based on two-dimensional image data.

A further object of the invention consists in reducing the amount of data required for the classification so that vehicle types, particularly also passenger car types, can be automatically evaluated more quickly.

The object is met according to the invention in a method for classifying a moving vehicle having the following method steps:
recording at least one image of a vehicle by means of a camera and determining the position and perspective orientation of the vehicle,
generating from three-dimensional vehicle models which are stored in a database rendered two-dimensional views in positions and perspective orientations in which the three-dimensional vehicle model could be perspectively orientated along an anticipated movement path of the vehicle relative to the camera,
comparing the at least one recorded image of the vehicle with the rendered two-dimensional views of the stored three-dimensional vehicle models and finding the two-dimensional view with the best match,
classifying the recorded vehicle with the three-dimensional vehicle model which best matches one of the two-dimensional views.

For generating the rendered two-dimensional views, a method step is assumed in which a two-dimensional view of the three-dimensional vehicle model is generated from a three-dimensional vehicle model by means of a projection on a defined plane corresponding to a selected or desired image capture plane.

The image is advantageously recorded in an installation position of the camera with a known distance and horizontal angle from the edge of a roadway over which the vehicle is moving and with a known vertical angle of the camera relative to the surface of the roadway. In this regard, it is particularly advisable to record the perspective orientation, the position and the dimension of the recorded vehicle by means of an image sequence comprising at least two images.

In a prior step for rendering the three-dimensional vehicle models corresponding to the perspective orientation and the dimension, an image sequence of a recorded reference vehicle is advisably captured and an image is selected therefrom at a selected position relative to the installation position of the camera, wherein two-dimensional views are rendered from a plurality of three-dimensional vehicle models for this selected position and are stored in a storage.

In a preferred variant of the method in a prior step for rendering the three-dimensional vehicle models corresponding to the perspective orientation and the dimension, a plurality of images are selected from the image sequence of a recorded reference vehicle at a plurality of selected positions of the vehicle relative to the installation position, wherein two-dimensional views of a plurality of three-dimensional vehicle models are rendered respectively for each of these selected positions and are stored in a storage.

In this connection, an interpolation can advantageously be carried out between two adjacent two-dimensional views of the plurality of two-dimensional views so that the comparison of the recorded vehicle with the two-dimensional views can be performed independent from the specifically selected position of the perspective orientation of the vehicle.

For the purpose of data reduction in a preferred variant of the method, an image section with evaluatable geometric structures is selected from the rendered two-dimensional views of all of the three-dimensional vehicle models, and an image portion corresponding to the reduced-data image section of the rendered two-dimensional views is extracted from the at least one recorded image of the vehicle.

For a more precise classification (determination of vehicle type) or for identification of vehicles (e.g., for penalizing traffic infractions), it proves advisable through the selection of the installation position of the camera to capture the recorded vehicle in a perspective orientation in at least one image with a license plate or other characteristic geometrical structures.

It is particularly advantageous when a rectification of the license plate is carried out based on the horizontal angle and vertical angle known from the installation position in order to automatically implement an optical character recognition (OCR).

It proves advantageous when the positions and dimensions of the recorded vehicle are determined by evaluating signals of a radar device.

The three-dimensional vehicle models in the database are preferably in the form of three-dimensional textured surface nets, and geometric structures may be additionally defined at the surface and in the interior of the three-dimensional vehicle models. For the latter option, it is advantageous when at least one passenger sitting position is defined in the interior of the three-dimensional vehicle models as a geometric structure of the three-dimensional vehicle models.

To improve the automated evaluation, the extraction of reduced-data image sections is advisably carried out corresponding to the geometric structures defined at the three-dimensional vehicle models.

It proves particularly advantageous to carry out a histogram match which is applied either to the image as a whole or in a locally adaptive manner such that a more accurate representation of detail can be achieved particularly in darker areas of the reduced-data image sections.

In a preferred variant of the method according to the invention, the following individual steps are advisably carried out for generating the rendered two-dimensional views:
compiling a database of three-dimensional vehicle models of a wide variety of vehicle types, wherein geometric structures are defined at the three-dimensional vehicle models and are provided for an evaluation,
determining a camera position for capturing vehicles moving in circulating traffic on a roadway by means of a camera, at least one image being captured at a known distance, angle and a known height with respect to the roadway so that a perspective orientation and the dimension of the vehicles to be recorded is predetermined,
orienting and dimensioning the three-dimensional vehicle models of the database corresponding to the movement path with fixed camera position and distance from the roadway,
generating and storing two-dimensional views of the three-dimensional vehicle models by rendering the oriented and dimensioned three-dimensional vehicle models from the database.

The invention proceeds from the basic idea that traffic monitoring using two-dimensional images of recorded vehicles still requires a considerable expenditure of manual postprocessing, e.g., when a more accurate classification of vehicles is required which goes beyond the detection of criteria for charging tolls and which extends to the identification of the vehicle involved in a traffic violation. Therefore, the present invention is directed to improving classification based on objective criteria by matching a plurality of three-dimensional vehicle models stored in a database to the installation position of a camera such that a two-dimensional reference image is available for the similarity comparison of the two-dimensional image of the recorded vehicle, which two-dimensional reference image is suitable for vehicle classification as well as for a subsequent automatic evaluation. In this regard, the method steps according to the invention for determining the installation position of the camera relative to the roadway and the perspectively adapted rendering of the three-dimensional model are the crucial prerequisites enabling the aimed-for improvement in the reliability of classification in an automated evaluation. In a preferred embodiment, it is even possible to carry out evaluations extending to vehicle identification by means of vehicle details such as license plate, vehicle lighting (e.g., headlight defects, infractions involving directional signals, etc.) or detection of passengers (e.g., number of passengers, determination of driver, cell phone infraction, etc.).

The invention makes it possible to achieve a reliable classification for vehicles moving in traffic based on two-dimensional image data, particularly also for passenger car types, to help reduce the amounts of data to be processed by quickly locating type-specific vehicle details and accordingly to allow an automatic evaluation of the vehicle details.

### BRIEF DESCRIPTION OF THE DRAWINGS:

The invention will be described in more detail in the following with reference to embodiment examples. The accompanying drawing shows:

FIG. 1 is a flowchart illustrating the method according to the invention.

### DESCRIPTION OF THE EMBODIMENTS

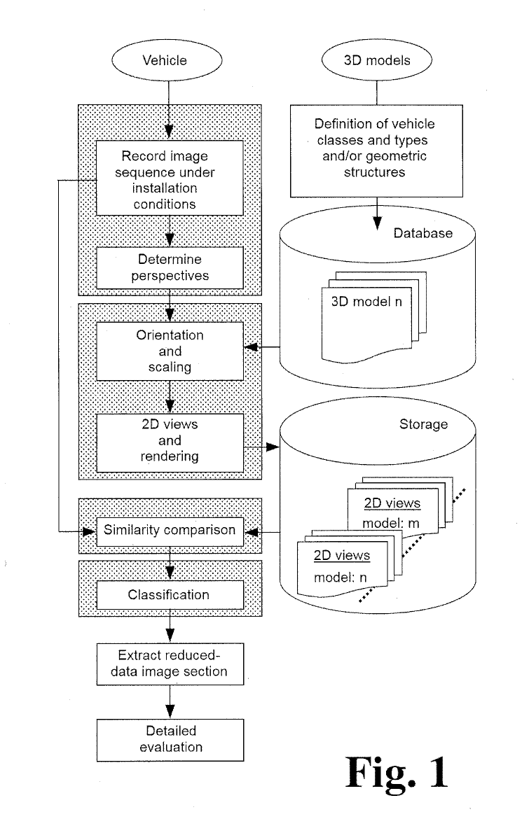

The method is carried out according to the method steps shown schematically in FIG. 1. The essential steps of the method according to the invention are shown in the boxes highlighted in gray.

In a first step, an image sequence of a vehicle moving in flowing traffic on a roadway is recorded by a camera which is directed to the roadway in an optional but fixed installation position. This image sequence can be formed of individual digital images or can be a video sequence. An unmodified image area captured in the image sequence will be referred to hereinafter as a scene.

The installation position which is defined relative to the vehicle is fundamentally defined by three distance values and three angle values by which the camera is oriented in a Cartesian coordinate system and views the scene. These six parameters are referred to in the technical literature as extrinsic parameters. The imaging of the scene inside the camera corresponds to the laws of imaging optics and is, often approximated by five parameters. These parameters are referred to in the technical literature as intrinsic parameters. A perspective of the camera relative to the scene is fully described by the total of eleven parameters. Generally, simplifications can be applied for practical application so that the number of parameters can be appreciably reduced. Often the intrinsic parameters are already known so that only the extrinsic parameters need be determined or estimated.

The extrinsic parameters can be determined, for example, in relation to the course of the roadway captured in the scene. For this purpose, the installation position of the camera can be defined based on a known vertical angle (orientation and distance relative to the surface of the roadway) and a known horizontal angle (orientation and distance relative to the edge of the roadway).

If the extrinsic parameters are not known, the installation position can be estimated by mathematical methods. For this purpose, parameter sets are generated on the basis of which the installation position may be deduced.

For example, parameter sets can be generated based on license plates which are located on vehicles and whose dimensions and proportions are known. For this purpose, the installation position is selected in such a way that the license plate can also be captured on the front of the vehicle in at least one image of the image sequence. This process is subsequently repeated for other passing vehicles so that the extrinsic parameters in the estimated installation position can gradually be optimized.

In addition, further information about the installation position can be gathered by estimating vanishing points. To estimate the vanishing point, an optical flow is evaluated in the image sequence. The optical flow is a vector field by which all of the image points moving in the image sequence can be described. The rate and direction of movement of the moving image points can be determined based on vectors.

The perspective is determined from a driving direction of the vehicle. For this purpose, an additional sensor, for example, a radar device, also determines the distance and angle of the vehicle relative to the installation position of the radar device and the velocity of the vehicle at the same time that the image is captured. The driving direction and, therefore, the perspective orientation of the recorded vehicle in the individual images can be determined from the values changing from one individual image to the other and from the arrangement of the radar device relative to the roadway, which is also known.

Alternatively or additionally, information about the geometrical relationship between a position of the vehicle and the installation position of the camera can be gathered from the optical flow and the course of the roadway. In particular, the specific spatial position of the vehicle, including the driving direction information, can be obtained from the vectors of the optical flow. For this purpose, it is assumed that the vectors of the optical flow which can be associated with an object generally move in planes extending parallel to the surface of the roadway. Corresponding to the recorded scene, the roadway is present as a three-dimensional roadway model which has been prepared and stored beforehand.

The time interval between two individual images on which the analysis of the optical flow is based can be back-calculated to a spatial distance by multiplying by the vehicle velocity determined by the radar. The back-calculated spatial distance allows the spatial position and orientation of the flow vector to be calculated in a manner known to one skilled in the art by photogrammetric methods.

With knowledge of the installation position of the camera, the perspective, position and dimensioning of the recorded vehicle can be determined in every individual image of the image sequence.

Three-dimensional vehicle models stored in a database are then oriented and scaled corresponding to the determined positions, perspectives and dimensions of the recorded vehicles and of the three-dimensional roadway model. The orientations and dimensions of all of the three-dimensional vehicle models stored in the database then correspond to those of the recorded vehicles from an individual image or from the images of an image sequence.

There are detailed three-dimensional vehicle models for many of the large variety of types of vehicles and these three-dimensional vehicle models are stored in the database in the form of three-dimensional textured surface nets. The three-dimensional vehicle models are already stored so as to be ordered by vehicle type and vehicle class. Determined geometric structures which are characteristic of the corresponding vehicle can be defined on the three-dimensional vehicle models for a subsequent detailed evaluation of the recorded vehicles. The geometric structures can be defined on the surface as well as in the interior of the three-dimensional vehicle model. Surface geometric structures include, for example, the license plate, the lighting system, the radiator grill, the front windshield and side windows, the roof or the wheels. The backrests of the seats or the steering wheel, for example, can be defined as inner geometric structures.

After the three-dimensional vehicle models have been oriented and scaled, one (in case of individual images) or more (in case of an image sequence) two-dimensional views are prepared for each three-dimensional vehicle model. This is done by rendering the three-dimensional vehicle models in one or more of the different positions. In theory, the quantity of possible two-dimensional views is very large. In order to reduce this quantity of possible two-dimensional views so as to economize on computing and storage resources, the three-dimensional vehicle models are mostly rendered in positions in which the three-dimensional vehicle model is guided along a three-dimensional roadway model which can be determined from the road position predetermined by the camera setup (e.g., by means of serial images of an optional reference vehicle recorded previously).

The rendered two-dimensional views are stored in a storage. Based on the three-dimensional vehicle models which have already been classified or typed, the two-dimensional views are also unambiguously assigned and can be used to recognize (classify or identify) the recorded vehicle. In order for the stored two-dimensional views to be used to recognize further recorded vehicles, it is necessary that the intrinsic and extrinsic parameters of the camera remain unchanged. In this way, a scene-adaptive database can be compiled as the quantity of recorded vehicles increases.

In another variant of the method, the perspective and the dimension of the recorded vehicle are determined in at least two images of the image sequence. The perspective and dimension can be interpolated between the two consecutively captured images such that the perspective and dimension can also be determined between the two images. In this way, a plurality of two-dimensional views of the three-dimensional vehicle model can be generated from two images in the method step described hereinafter and are stored in the storage. Due to the presence of a plurality of two-dimensional views, the comparison of the recorded vehicle is no longer limited to a particular image of the image sequence, so that the method becomes more flexible. For example, cornering and parameters thereof can be deduced from a changing perspective orientation of the vehicle in two consecutively recorded images.

The recognition of the different vehicles is carried out in a further method step through a similarity comparison of the image or images of the recorded vehicle with the two-dimensional views stored in the storage. In the simplest instance, it is sufficient when an individual image in which each of the different recorded vehicles has been recorded every time at the same location relative to the installation position of the camera is used for the similarity comparison. In this case, after a one-time determination of the perspective of a first recorded vehicle used as reference vehicle the perspectives of all of the other recorded vehicles can also be deduced. All of the other vehicles occupy a perspective which is comparable with the two-dimensional view.

If it is impossible in the captured scene to always record the vehicle at the same location, any image from the recorded image sequence of the recorded vehicle can also be used for the similarity comparison. It is then also possible to determine the perspective of the recorded vehicle in any given individual image of the image sequence by the procedure described above.

During the similarity comparison, the recorded vehicle is analyzed for similarity to the two-dimensional views. As a result of the comparison, the three-dimensional vehicle model with the best match to the recorded vehicle is determined. By associating with a vehicle class or a vehicle type connected to the determined three-dimensional vehicle model, the recorded vehicle is likewise classified after the comparison.

If geometric structures are defined on the assigned three-dimensional vehicle model, they are transferred into the two-dimensional view when rendering and used for isolating corresponding image sections or for determining image areas of the image of the recorded vehicle which are to be examined more closely. This appreciably reduces the amount of data to be evaluated.

In addition to classification, more detailed evaluations can be carried out based on the image sections. The image sections or image areas are optimized for this purpose by means of suitable image processing routines and are subjected to an automatic evaluation. An effective optimizing routine to apply is, for example, a histogram match by which the brightness or the contrast range of the entire two-dimensional view (the image as a whole) or of the image section (locally adaptive) can be adjusted. To adjust the contrast range, a distribution of brightness values which is really present in the image and which is generally limited is transformed to the entire brightness range available in the spectrogram. An improved distribution of the coloration can be achieved in this way. To adjust the brightness, the generally limited distribution of brightness values occurring in the image can be shifted within the histogram so that either a lightening or a darkening of the image takes place. A more detailed depiction can be achieved in the dark images or image sections in this way.

With regard to the license plate, the image section is first rectified with respect to perspective based on the known installation position of the camera. After rectification, the contents of the license plate can be read by means of automatic character recognition (OCR). In this way, the classed vehicle can also be identified and assigned to a vehicle owner.

In the image section of the front windshield, the image area in which the head of the driver or the position of the front seat passenger can be expected can be deduced based on the known position of the backrests typical of the vehicle. The image area with the head of the driver can be processed by means for improving image quality so that it is possible subsequently in automated processes, for example, to identify faces, to check for use of safety belts or to provide evidence that the driver was telephoning, smoking, drinking or eating. The position of the front seat passenger can be faded out automatically in the total image area of the front windshield to maintain anonymity.

Based on the image section of all of the windows in conjunction with the positions of the backrests, the recorded vehicle can also be checked for the total number of passengers. In this way, the use of certain lanes based on occupancy of the vehicle can be monitored, e.g., for HOV (high occupancy vehicles).

The image sections of the lighting systems can be evaluated for defects or for use of lighting appropriate to the situation. However, they can also be used exclusively for type classification.

Based on the quantity of geometric structures of the determined three-dimensional vehicle model which are defined as wheels, the number of axles of the recorded vehicle is known. The vehicle can be classified more easily in this way, particularly for calculating road tolls. When the image sections of the wheels are also evaluated, the position of vehicles with a lifting axle can also be checked.

In order to reduce the amount of data required for the three-dimensional vehicle models when the method is used for the classification of trucks with semi-trailers or other vehicle combinations (e.g., trucks with trailers or passenger cars with car trailers), the three-dimensional models for the semi-trailers and trailers are produced separately. The three-dimensional vehicle models of the truck, passenger car, semi-trailer and trailer can be combined in any way for vehicle recognition. It is also possible to store evaluatable add-on parts, e.g., roof receptacles, bicycle racks, etc., as individual three-dimensional models.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed is:

1. A method for classifying a moving vehicle comprising the following method steps:
recording at least one image of a vehicle by means of a camera and determining position and perspective orientation of the vehicle,
generating from three-dimensional vehicle models which are stored in a database rendered two-dimensional views in positions and perspective orientations in which the three-dimensional vehicle model could be perspectively orientated along an anticipated movement path of the vehicle relative to the camera,
comparing the at least one recorded image of the vehicle with the rendered two-dimensional views of the stored three-dimensional vehicle models and finding the two-dimensional view with the best match, and
classifying the recorded vehicle with the three-dimensional vehicle model which best matches one of the two-dimensional views.

2. The method according to claim 1, wherein the image is recorded in an installation position of the camera with a known distance and horizontal angle from the edge of a roadway over which the vehicle is moving and with a known vertical angle of the camera relative to the surface of the roadway.

3. The method according to claim 1, wherein in the perspective orientation, the position and the dimension of the recorded vehicle are determined by means of an image sequence comprising at least two images.

4. The method according to claim 1, wherein in a prior step for rendering the three-dimensional vehicle models corresponding to the perspective orientation and the dimension, an image sequence of a recorded reference vehicle is captured and an image is selected therefrom at a selected position relative to the installation position of the camera, wherein two-dimensional views are rendered from a plurality of three-dimensional vehicle models for the selected position and are stored in a storage.

5. The method according to claim 4, wherein in a prior step for rendering the three-dimensional vehicle models corresponding to the perspective orientation and the dimension, a plurality of images are selected from the image sequence of a recorded reference vehicle at a plurality of selected positions of the vehicle relative to the installation position, wherein two-dimensional views of a plurality of three-dimensional vehicle models are rendered respectively for each of these selected positions and are stored in a storage.

6. The method according to claim 5, wherein an interpolation is possible between two adjacent two-dimensional views of the plurality of two-dimensional views so that the comparison of the recorded vehicle with the two-dimensional views can be performed independent from the specifically selected position of the perspective orientation of the vehicle.

7. The method according to claim 1, wherein a reduced-data image section with evaluatable geometric structures is selected from the rendered two-dimensional views of all of the three-dimensional vehicle models, and an image portion corresponding to the reduced-data image section of the rendered two-dimensional views is extracted from the at least one recorded image of the vehicle.

8. The method according to claim 1, wherein the recorded vehicle is captured in at least one image in a perspective orientation with a license plate or other characteristic geometrical structures through selection of the installation position of the camera.

9. The method according to claim 8, wherein a rectification of the license plate is carried out based on the horizontal angle and vertical angle known from the installation position in order to automatically implement an optical character recognition (OCR).

10. The method according to claim 1, wherein the positions and dimensions of the recorded vehicle are determined by evaluating signals of a radar device.

11. The method according to claim 1, wherein the three-dimensional vehicle models in the database are in the form of three-dimensional textured surface nets, wherein geometric structures are defined at the surface and in the interior of the three-dimensional vehicle models.

12. The method according to claim 11, wherein at least one passenger sitting position is defined in the interior of the three-dimensional vehicle models as a geometric structure of the three-dimensional vehicle models.

13. The method according to claim 6, wherein the extraction of reduced-data image sections is carried out corresponding to the geometric structures defined at the three-dimensional vehicle models.

14. The method according to claim 1, wherein a more accurate representation of detail can be achieved in darker areas of the reduced-data image sections by applying a histogram match which is applied either to the image as a whole or in a locally adaptive manner.

15. The method according to claim 1, generating the rendered two-dimensional views comprises:
compiling a database of three-dimensional vehicle models of a wide variety of vehicle types, wherein geometric structures are defined at the three-dimensional vehicle models and are provided for an evaluation,
determining a camera position for capturing vehicles moving in circulating traffic on a roadway by means of a camera, wherein at least one image is captured at a known distance, angle and a known height with respect to the roadway so that a perspective orientation and the dimension of the vehicles to be recorded is predetermined,
orienting and dimensioning the three-dimensional vehicle models of the database corresponding to the movement path with fixed camera position and distance from the roadway, and
generating and storing two-dimensional views of the three-dimensional vehicle models by rendering the oriented and dimensioned three-dimensional vehicle models from the database.
